(19) United States
(12) Patent Application Publication
(10) Pub. No.: US 2002/0079658 A1
(43) Pub. Date: Jun. 27, 2002

(54) Connecting organ

(76) Inventors: Maarten Bobbert, Amstelveen (NL); Gerrit de Groot, Haarlem (NL); Johannes Hendricus Petrus Houdijk, Amsterdam (NL); Jacobus Jozef de Koning, Langeraar (NL); Hans Meester, Leiden (NL); Albert Wilhelm Schreurs, Leiden (NL)

Correspondence Address: FOLEY, HOAG & ELIOT, LLP, PATENT GROUP, ONE POST OFFICE SQUARE, BOSTON, MA, 02109, US

(21) Appl. No.: 10/002,263

(22) Filed: Nov. 2, 2001

Related U.S. Application Data
(63) Continuation of application No. PCT/NL00/00289, filed on May 3, 2000.

(30) Foreign Application Priority Data
May 6, 1999 (NL) 1011985

(51) Int. Cl. B62B 15/00

(52) U.S. Cl. 280/14.28; 280/14.21

(57) ABSTRACT

A connecting organ for coupling a shoe with a sporting device such as a skate or a roller skate, ski or the like, such as to be pivotable around a pivoting point, which is equipped with a first and a second pivoting point which during use are successively active with a progression of a foot's bending. the shoe can be mounted onto a support element which at a first end thereof liftably rests upon the sporting device and at a second end removed from the first end is via the first pivoting point connected with an end of a coupling element whose other end is connected via the second pivoting point with a connecting organ that is mounted on the sporting device.

### CROSS-REFERENCE TO RELATED APPLICATION

This is a continuation application of PCT/NL00/00289 filed May 3, 2000, which PCT application claims priority of Dutch patent application number 1011985 filed May 6, 1999, herein incorporated by reference.

### FIELD OF THE INVENTION

The invention relates to a connecting organ for coupling a shoe with a sporting device such as an ice skate or a roller skate, ski or the like, such as to be pivotable around a pivoting point.

### BACKGROUND OF THE INVENTION

A connecting organ of this type is disclosed in the international patent application PCT/NL96/00209, published under No. WO 96/37269. The known connecting organ focuses on a more efficient transfer of the forces from the thrusting foot to the supporting device. According to said publication it is not possible to realize this objective with a simple construction. Consequently, the embodiment of the prior art connecting organ is very complicated, which does not help to make it less susceptible to break-down, while moreover the desired improved efficiency of transferring the foot's force to the sporting device is not really optimal.

The prior art connecting organ is embodied with a pivoting point located at the front of the sporting device. The shoe is coupled with the sporting device via the connecting organ by means of a subframe comprising different pivoting points. Said pivoting points make it possible for the foot to be released from the sporting device by rotating about the above mentioned first pivoting point.

From CH-A-59,397 a connecting organ according to the preamble is known, equipped with a first and a second pivoting point which during use are successively active with the progression of the foot's bending movement.

### SUMMARY OF THE INVENTION

It is an object of the invention to provide a connecting organ that is not complicated and as a result not very susceptible to break-down, while being simple to adjust and in addition, optimizing the efficiency of transferring the force to the sporting element when the foot is bending during the thrust.

The connecting organ according to the invention is characterized in that the shoe can be mounted onto a support element which at a first end thereof liftably rests upon the sporting device, and that at a second end removed from the first end is via the first pivoting point connected with an end of a coupling element whose other end is connected via the second pivoting point with a connecting organ that is mounted on the sporting device.

In a further aspect of the invention the connecting organ is preferably embodied such that in the course of being lifted off the sporting device, the support element rotates over an adjustable angle about a point near the pivoting points, transversely to the longitudinal direction of the sporting device. This measure makes that during straightening of the thrusting leg, and in particular during straightening of the ankle, a subtle correction is effected that serves to keep the sporting device, for example, a skate blade in position on the ground surface, which further improves the efficiency of the thrusting movement.

A preferred embodiment of the connecting organ with which this may be realized is characterized in that both the coupling element and the connecting organ are articulated, having two adjoining coupling parts, respectively connecting parts with curved contact surface facing each other, which allow the coupling parts and connecting parts to move in relation to one another in order to set the second pivot at an angle, and in that fixing means are provided for fixing the contact surface of the coupling parts and connecting parts in a predetermined position, and for fixing the respective orientation of the second pivot in relation to the longitudinal direction of the sporting device.

The connecting organ according to the invention is equipped with a first and a second pivoting point, which during use are active successively with the progression of the foot's bending movement. This surprisingly simple measure particularly serves the efficacy of the thrusting movement due to the fact that the bending movement of the foot during thrusting can be followed closely. To this end it is advantageous for the first pivoting point to be located substantially in the vicinity of the ball of a foot which during use is inside the shoe, and which pivoting point is active in the first stage of the foot's bending, and further that during use the second pivoting point is located in front of the foot and is active in the second and last stage of the foot's bending movement.

The connecting organ is then preferably equipped such that the first and second pivoting points are active in succession without being active simultaneously.

### BRIEF DESCRIPTION OF THE DRAWINGS

Herein below the invention will be further elucidated with reference to the drawing, which in a non-limiting exemplary embodiment shows the connecting organ according to the invention applied to a skate blade. The drawing shows in:

FIG. 1 the connecting organ according to the invention used in combination with a skate blade in exploded view, and

FIG. 2 the connecting organ according to the invention used in combination with a skate blade in mounted condition.

### DESCRIPTION OF THE PREFERRED EMBODIMENT

In the figures similar parts are indicated with identical reference numbers. For the sake of completeness it is remarked that although the illustrated exemplary embodiment shows the connecting organ in connection with an ice skate, the invention is not limited to this application and that the connecting organ according to the invention may be used equally effectively with other kinds of sporting devices such as roller skates, skis and the like.

Referring first to FIG. 2, the connecting organ according to the invention is generally indicated with reference number 1. The connecting organ 1 is provided with a first pivoting point 2 and a second pivoting point 3, which during use are active successively with the progression of the foot's bending movement. The foot is inside a shoe (not shown) that is mounted on a support element 4, which at a first end 5 thereof liftably rests upon a skate blade 6, and that at a second end removed from the first end 5 is via the first pivoting point 2 connected with an end of a coupling element 8 whose other end is connected via the second pivoting point 3 with a connecting organ 9 that is mounted on the skate blade 6. FIG. 2 clearly shows that the first pivoting point 2 is located substantially in the vicinity of the ball of a foot that during use is inside the shoe (not shown), and which is active in the first stage of the thrust, that is to say the first part of the foot's bending movement. The second pivoting point 3 is located in front of the foot and comes into action in the second and last stage of the thrust and the corresponding bending movement of the foot.

By means of this construction according to the invention a thrust progressing in two stages is realized, wherein in the first stage preferably only the first pivoting point 2 is activated, and at a further adjustable moment the second pivoting point 3 is activated. The second pivoting point 3 is then positioned such that in this last stage an elongated lever is formed, whereby contact of the skate blade 6 with the ice is prolonged so that the thrust takes place with greater efficiency.

To adjust the moment at which the second pivoting point 3 becomes active, which coincides with the moment at which the first pivoting point 2 has completed its whole effect, various solutions are possible within the scope of the person skilled in the art. For example, the support element 4 may be provided with an adjustable stop which can be secured at a desired position by means of a set screw and which determines the maximal rotation of the support element 4 in relation to the coupling element 8. The expert is well acquainted with such a solution and no further explanation is required.

For the sake of completeness, the fig. also shows a torsion spring 10 which, in the resting state, serves to push the support element 4 with the mounted shoe in the direction of the skate blade 6.

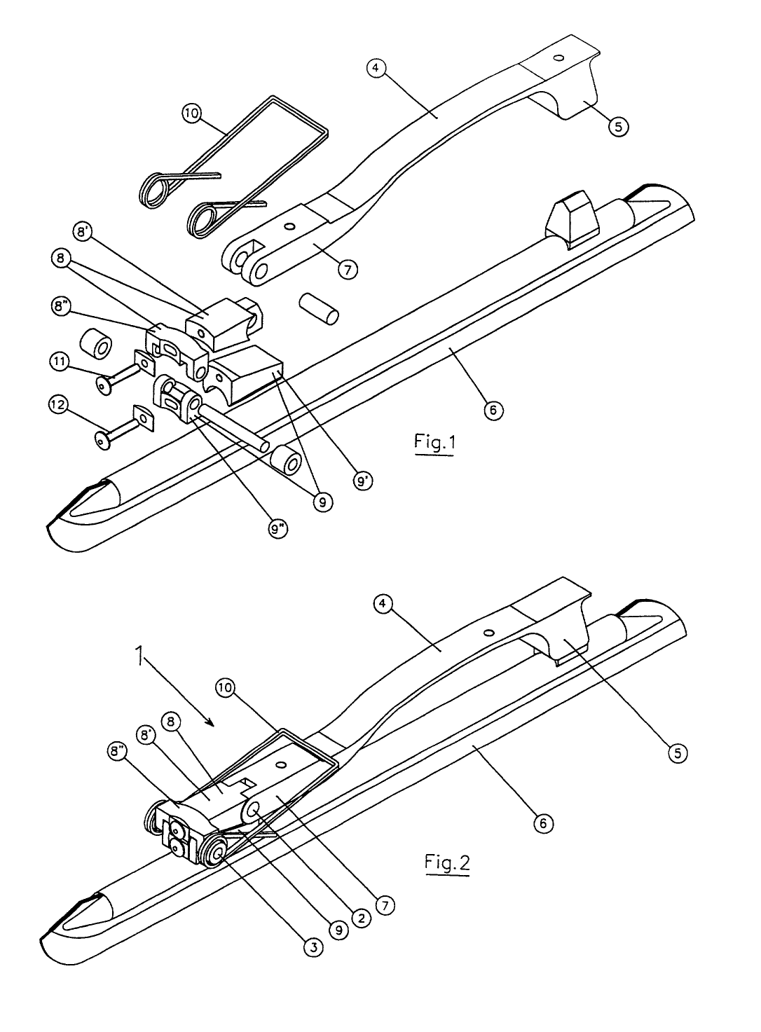

The figs. further show—this is especially clear in FIG. 1—that both the coupling element 8 and the connecting organ 9 are articulated, having two adjoining coupling parts 8′, 8″, respectively connecting parts 9′, 9″. Both the coupling parts 8′, 8″ and the connecting parts 9′, 9″ have curved contact surface facing each other, as can be clearly seen in FIG. 1. These contact surfaces allow the coupling parts 8′, 8″ and the connecting parts 9′, 9″ to move in relation to one another whereby the second pivot 3 can be set at an angle in relation to the longitudinal direction of the skate blade 6.

Also provided are fixing means, for example screws 11 and 12 for fixing the coupling parts 8′, 8″ and connecting parts 9′, 9″ in a predetermined position of the contact surfaces. Adjusting the adjacent contact surfaces thus fixes the respective orientation of the second pivot 3 in relation to the longitudinal direction of the skate blade 6 in the desired position. This further improves the efficiency during straightening of the thrusting leg, and in particular during straightening of the ankle, due to the fact that the support element 4, in the course of the skate blade 6 being lifted off, rotates over a small angle about the second pivoting point 3 as virtual pivoting point and transversely to the longitudinal direction of the skate blade 6, which angle is adjustable in accordance with the angle at which the second pivot 3 is set.

What is claimed is:

1. A connecting organ for coupling a shoe with a sporting device such as an ice skate or a roller skate, ski or the like, such as to be pivotable around a pivoting point, which is equipped with a first and a second pivoting point which during use are successively active with a progression of a foot's bending movement, wherein the shoe can be mounted onto a support element which at a first end thereof liftably rests upon said sporting device, and which at a second end removed from said first end is connected via said first pivoting point with an end of a coupling element whose other end is connected via said second pivoting point with a connecting organ that is mounted on the sporting device.

2. A connecting organ according to claim 1, wherein in the course of being lifted off the sporting device, said support element rotates over an adjustable angle about a point near said pivoting points and transversely to a longitudinal direction of the sporting device.

3. A connecting organ according to claim 1, wherein both said coupling element and said connecting organ are articulated, having two adjoining coupling parts, respectively connecting parts with curved contact surface facing each other, which allow said coupling parts and connecting parts to move in relation to one another in order to set said second pivot at an angle, and wherein fixing means are provided for fixing said contact surface of said coupling parts and connecting parts in a predetermined position, and for fixing a respective orientation of said second pivot in relation to a longitudinal direction of the sporting device.

4. A connecting organ according to claim 1, wherein said first pivoting point is substantially in the vicinity of a ball of the foot which during use is inside the shoe, and which pivoting point is active in a first stage of the foot's bending.

5. A connecting organ according to claim 1, wherein during use said second pivoting point is located in front of the foot and is active in a second and last stage of the foot's bending movement.

6. A connecting organ according to claim 1, wherein said first and second pivoting points are active in succession without being active simultaneously.
